(19) United States
(12) Patent Application Publication
(10) Pub. No.: US 2008/0232780 A1
(43) Pub. Date: Sep. 25, 2008

(54) IMAGING SYSTEM AND IMAGING APPARATUS

(75) Inventor: Toshiaki YAMADA, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/053,566

(22) Filed: Mar. 22, 2008

(30) Foreign Application Priority Data
Mar. 23, 2007 (JP) 2007-076615

(51) Int. Cl. H04N 5/00

(52) U.S. Cl. 386/117

(57) ABSTRACT

A camera system consists of a primary digital camera and at least a secondary digital camera. When a shutter button of the primary digital camera is operated after it is set up with conditions for successive shots, the primary digital camera produces a composite sound signal by encoding data of the set conditions for successive shots and superimposing the encoded data on a sound signal, and outputs the composite sound signal through a speaker. The secondary digital camera catches the composite sound signal through a microphone, and decodes the composite sound signal to detect the data of the set conditions for successive shots. According to the set conditions for successive shots, the primary and secondary cameras execute a synchronized successive shot process.

### FIELD OF THE INVENTION

The present invention relates to an imaging system that can make synchronized successive shots using a plurality of imaging apparatuses, and relates also to the imaging apparatuses for this system.

### BACKGROUND OF THE INVENTION

A monitoring system using a plurality of monitoring cameras has generally been known as a remote control system for imaging apparatuses like digital cameras. The conventional monitoring system needs a large-scale expensive apparatus for the remote control. As a prior art to overcome the disadvantages of the conventional monitoring system, an imaging system has been known for example from JPA Hei 8-084282, wherein a plurality of digital cameras are connected through cables, so that the digital cameras exchange control signals to make mutual remote control.

In order to make it easy for a plurality of photographers to take pictures under a common intension, an imaging system has been suggested for example in JPA 2001-008089, wherein information on imaging carried out by an imaging apparatus is sent to a secondary imaging apparatus, so the secondary imaging apparatus may use the information as supportive information for its imaging process. Also a study has been made for making use of the imaging systems as above to take pictures successively by the plurality of imaging apparatuses while synchronizing them with each other.

However, because the imaging system of the first mentioned prior art connects the imaging apparatuses through cables, it is necessary to provide a specific communication module for processing the synchronized successive shots. Such a communication module will raise the production cost of the system. Beside that, the need to carry about and connect the cables for installation of this system is cumbersome and labor-consuming. The imaging system of the next mentioned prior art exchanges the information through a wireless communication between the imaging apparatuses, so it is also necessary to provide a specific communication module for processing the synchronized successive shots, and thus the production cost becomes expensive. Beside that, the user needs to make cumbersome setting operations for the wireless communication.

### SUMMARY OF THE INVENTION

In view of the foregoing, a primary object of the present invention is to provide an imaging system that can make synchronized successive shots using a plurality of imaging apparatuses, and the imaging apparatuses for this system, which are simple in construction, easy to operate, and produced at a low cost.

According to the present invention, an imaging system comprises a primary imaging apparatus and at least a secondary imaging apparatus, wherein the primary imaging apparatus comprises a first imaging device for converting an optical image of a subject into electronic image data; a first controller for controlling the first imaging device to execute a successive shot process according to conditions set up for successive shots; a device for producing a composite sound signal by encoding data of the conditions for successive shots and superimposing the encoded data on a predetermined sound signal; and a speaker for outputting the composite sound signal as a sound, whereas the secondary imaging apparatus comprises a second imaging device for converting an optical image of a subject into an electric image signal; a microphone for obtaining a sound signal from an external sound; a data detector for decoding the composite sound signal as it is obtained through the microphone, to detect the data of the conditions for successive shots; and a second controller for controlling the second imaging device to execute a successive shot process on the basis of the data of the conditions for successive shots.

To synchronize the imaging apparatuses with each other, it is unnecessary to set up specific conditions for communication between them or provide a special communication module, which would be necessary where the cameras are connected through WLAN, Bluetooth or cables. Thus the camera system of the above embodiment can accomplish the synchronized successive shot process with the above-described simple configuration, saves the production cost and eases the operational work.

Preferably, the primary imaging apparatus outputs the composite sound signal when an input device for inputting a command for starting imaging is operated. According to this embodiment, the predetermined sound signal may be a sound signal for a shutter sound or another unspecific registered sound.

According to a preferred embodiment, the primary and secondary imaging apparatuses have a normal imaging mode for taking a single shot, and a successive shot mode for taking a plural number of shots successively, and wherein when the primary imaging apparatus is set to the successive shot mode, the speaker outputs a specific sound signal that is different from a sound signal in the normal imaging mode, so the second controller sets the secondary imaging apparatus to the successive shot mode when the specific sound signal is obtained through the microphone. Thereby, the user does not need to set the secondary imaging apparatus to the successive shot mode.

Providing the secondary imaging apparatus with a storage device for storing the data of the conditions for successive shots temporarily makes sure for the secondary imaging apparatus to obtaining the condition data.

Outputting the composite sound signal before each shot so that the second controller obtains the data of the conditions for successive shots before each shot makes it possible to change the condition for successive shot during the successive shot process.

Preferably, the second controller judges whether a previous one of the successive shots is correct or not on the basis of the data of the conditions used for the previous shot, and if the previous shot is incorrect, the second controller revises the data of the conditions for successive shots.

According to another preferred embodiment, the primary imaging apparatus further comprises a first timer for outputting a timing signal and a light emitter, whereas the secondary imaging apparatus further comprises a second timer for outputting a timing signal, and wherein the first controller controls the light emitter to blink in accordance with the timing signal from the first timer, and the second controller detects the blinks of the light emitter through the second imaging device and adjusts the timing signal from the second timer to the timing signal from the first timer on the basis of the blinks of the light emitter. Thereby, the imaging apparatuses are precisely synchronized with each other during the successive shot process.

According to another preferred embodiment, the primary and secondary imaging apparatuses further comprise a clock device for outputting exact time, and the data of the conditions for successive shots include information designating the time of starting successive shots and the timing of successive shots, so the first and second controller execute the successive shot process from the designated time at the designated timing. This embodiment also makes sure to synchronize the imaging apparatuses precisely with each other during the successive shot process.

According to a further embodiment, the primary and secondary imaging apparatuses further comprise first and second wireless communication devices respectively and have a wireless setup mode for setting up wireless communication between the primary and secondary imaging apparatuses, and when the primary and secondary imaging apparatuses are set to the wireless setup mode, the first controller controls the composite sound signal producing device to encode wireless communication setup information for the first wireless communication device and superimpose the encoded wireless communication setup information on a sound signal to produce a composite sound signal, whereas the second controller controls the data detector to detect the wireless communication setup information and sets up the second wireless communication device on the basis of the detected wireless communication setup information. Thus, the user does not need to set up the wireless communication.

Registering user's voice or identifying information in the primary and secondary imaging apparatuses in advance ensures security of communication between the imaging apparatuses of the system.

Preferably, the input device comprises a two-step operating button, and the first controller controls the speaker to output the composite sound signal when the operating button is pressed halfway, and a sound notifying of the start of successive shots when the operating button is pressed fully to input the command for starting imaging, whereas the second control device controls the second imaging device to start the successive shot process upon receipt of the sound notifying of the start of successive shots. Thus, the time lag due to the decoding of the composite sound signal is reduced.

According to another preferred embodiment, the secondary imaging apparatus further comprises a device for giving a notice to the primary imaging apparatus that the secondary imaging apparatus completes setting up the conditions for successive shots on the basis of the data of the conditions for successive shots, so the primary imaging device outputs a sound notifying of the start of successive shots upon receipt of the notice from the secondary imaging device, and the secondary imaging apparatus starts the successive shot process upon receipt of the sound notifying of the start of successive shots. This embodiment also reduces the time lag due to the decoding of the composite sound signal.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a camera system of the present invention;

FIG. 2 is a front perspective view of a digital camera of the camera system;

FIG. 3 is a rear view of the digital camera;

FIG. 4 is block diagram illustrating an electric structure of the digital camera;

FIGS. 5A, 5B, 5C, 5D and 5E are explanatory diagrams illustrating how a composite sound signal is produced;

FIG. 6 is a flowchart illustrating a synchronized successive shot process of the camera system;

FIG. 7 is a block diagram illustrating part of an electric structure of a digital camera, wherein a buffer memory is provided between a decode/encode processor and a system controller;

FIG. 8 is a flowchart illustrating a synchronized successive shot process of the camera system, wherein a secondary camera is automatically set to a synchronized successive shot mode when it detects a specific shutter sound;

FIG. 9 is a flowchart illustrating a synchronized successive shot process of the camera system, including a step of judging whether a previous shot was correct or not;

FIG. 10 is a block diagram illustrating part of an electric structure of a digital camera provided with a timer;

FIG. 11 is a flowchart illustrating a synchronized successive shot process of the camera system, wherein the timing of successive shots corrects a time lag;

FIG. 12 is a block diagram illustrating part of an electric structure of a digital camera provided with a clock;

FIG. 13 is a flowchart illustrating a synchronized successive shot process of the camera system, wherein the timing of successive shots is decided based on time information;

FIG. 14 is a block diagram illustrating part of an electric structure of a digital camera provided with a timer;

FIG. 15 is a flowchart illustrating a wireless communication setup process of the camera system;

FIG. 16 is a flowchart illustrating a wireless communication setup process of the camera system, wherein wireless communication setup information is output as being superimposed on previously registered voice data;

FIG. 17 is a flowchart illustrating a wireless communication setup process of the camera system, wherein the magnitude of OFDM modified data is gradually raised up;

FIGS. 18A, 18B, 18C, 18D and 18E are explanatory diagrams illustrating how the magnitude of an OFDM signal is raised up;

FIG. 19 is a flowchart illustrating a synchronized successive shot process of the camera system, wherein an ID code is sent from a primary camera to a secondary camera through a supplemental light;

FIG. 20 is a flowchart illustrating a synchronized successive shot process of the camera system, wherein an ID code is sent from a primary camera to a secondary camera through an infrared data association;

FIG. 21 is a flowchart illustrating a synchronized successive shot process of the camera system, wherein an ID code is sent from a primary camera to a secondary camera through a recording medium;

FIG. 22 is a flowchart illustrating a synchronized successive shot process of the camera system, wherein an ID code is sent from a primary camera to a secondary camera through a display device of the primary camera and an imaging device of the secondary camera;

FIG. 23 is a flowchart illustrating a synchronized successive shot process of the camera system, wherein a primary camera notifies a secondary camera of the start and the end of each series of successive shots; and

FIG. 24 is a flowchart illustrating a synchronized successive shot process of the camera system, wherein a secondary camera notifies a primary camera that the secondary camera is ready for successive shots after setting up conditions for successive shots based on condition data from the primary camera.

### DESCRIPTION OF THE PREFERRED EMBODIMENTS

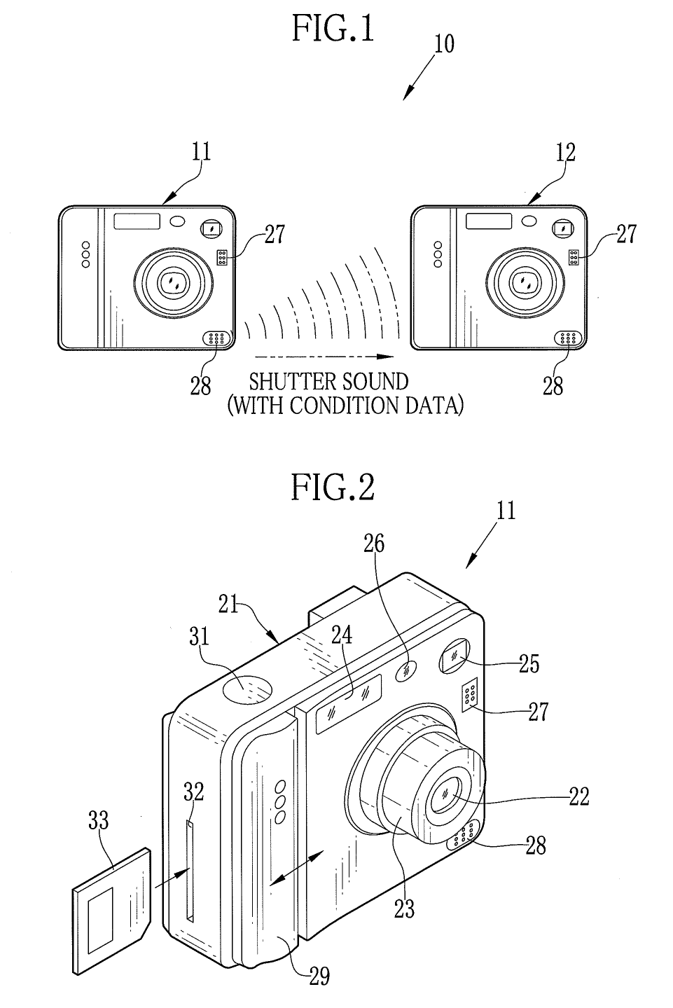

An imaging system 10 shown in FIG. 1 consists of two digital cameras 11 and 12 as primary and secondary imaging apparatuses. The digital cameras 11 and 12 of the camera system 10 can execute a synchronized successive shot process, wherein both of the digital cameras 11 and 12 take pictures successively under the same imaging conditions. The digital cameras 11 and 12 have a normal shot mode for taking a picture at a time and a synchronized successive shot mode.

In the synchronized successive shot mode, the digital camera 11 decodes successive shot condition data that represent imaging conditions for the synchronized successive shot process, hereinafter referred to as the synchronized successive shot conditions. The digital camera 11 overlays the decoded data on a sound signal, and sends the sound signal with the decoded data overlaid thereon to the other digital camera 12. Upon receipt of the successive shot condition data, the digital camera 12 sets up the same synchronized successive shot conditions. Thus, these digital cameras 11 and 12 can make the synchronized successive shot process under the same conditions. Note that the synchronized successive shot conditions represented by the successive shot condition data include for example the number of successive shots, the speed of successive shots, the shutter speed of each shot and the aperture value.

Referring now to FIG. 2 illustrating the digital camera 11 viewed from a front side of its camera body 21, the digital camera 11 is provided with a lens barrel 23 having an imaging lens 22, a flash projector 24, a finder objective window 25, a supplement light emitter 26, a microphone 27, a speaker 28 and a grip 29. The grip 29 doubles as a power switch member 29 that slides laterally to power the camera 11 on and off.

A shutter button 31 is provided on a top side of the camera body 21, and a media slot 32 is provided on one side of the camera body 21. In the media slot 32 is removably loaded a recording media like a memory card 33 for recording image data.

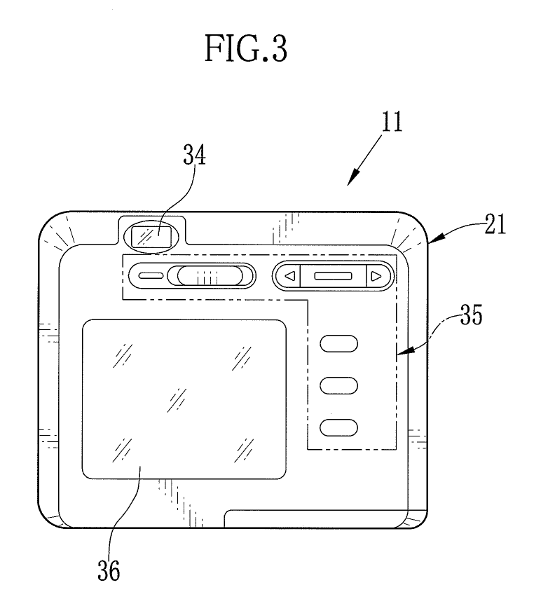

As shown in FIG. 3, a finer eyepiece window 34, an operating section 35 consisting of a plurality of operational buttons and an LCD 36 as a display device are provided on a rear side of the camera body 21. The digital camera 12 has the same structure as the digital camera 11.

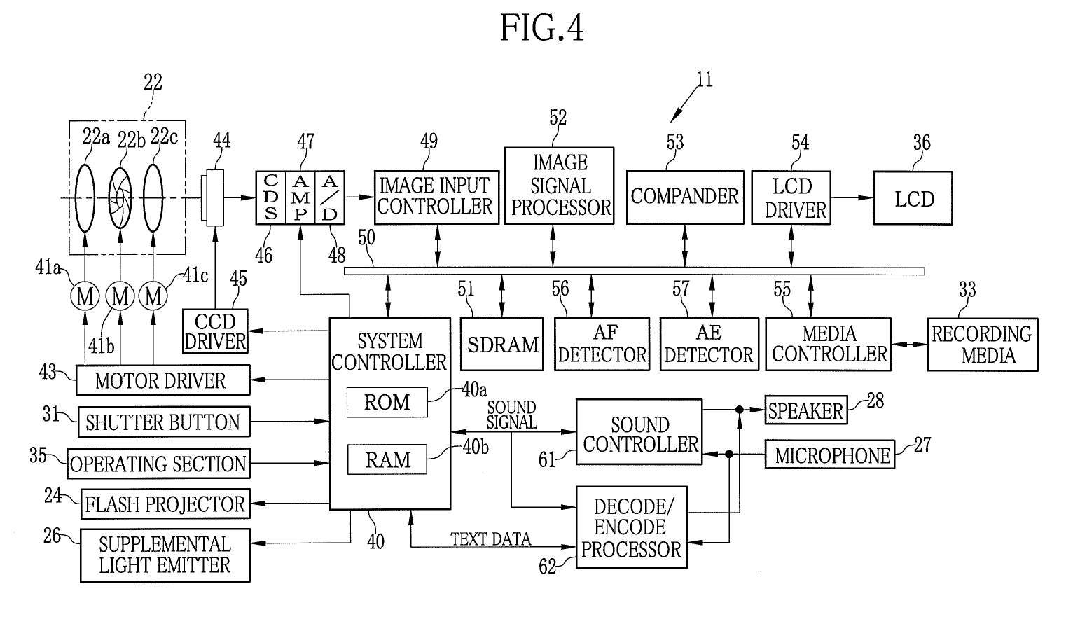

Next an electrical structure of the digital camera 11 will be described with reference to FIG. 4. The digital camera 11 is provided with a system controller 40 as a first control device for controlling respective components of the digital camera 11. The shutter button 31 and the operating section 35 are connected to the system controller 40.

The shutter button 31 is a two-step push button, which turns a not-shown first switch on at the first step where the shutter button 31 is pressed halfway, and the system controller 40 executes a preparatory process for imaging, such as an auto-focusing (AF) process and an auto-exposure control (AE) process. When the shutter button 31 is pressed fully, a not-shown second switch is turned on, whereby the system controller 40 executes an imaging process at an exposure value determined by the AE process.

The system controller 40 also receives operational signals from the respective operational buttons of the operating section 35, and executes a process corresponding to the received operational signal.

The system controller 40 has a ROM 40a and a RAM 40b built therein. The ROM 40a stores control programs and various control data for controlling the components of the digital camera 11. The RAM 40b temporarily store data for working the digital camera 11. Based on these control programs and data, the system controller 40 controls the respective components to execute many processes.

The imaging lens 22 consists of a zoom lens 22a, a stop 22b and a focus lens 22c. The zoom lens 22a is driven by a zoom motor 41a to move along an optical axis of the imaging lens 22. The stop 22b is driven by an iris motor 41b to change the aperture size, controlling the light amount from the subject to a photosensitive surface of a CCD image sensor 44, hereinafter called simply the CCD.

The focus lens 22c is driven by a focus motor 41c along the optical axis of the imaging lens 22. The motors 41a to 41c are connected through a motor driver 43 to a system controller 40. The motor driver 43 sends drive pulses to the motors 41a to 41c under the control of the system controller 40, so the motors 41a to 41c drive the imaging lens 22 according to the drive pulses.

Behind the imaging lens 22 is disposed a CCD 44 so that an optical image of the subject is formed by the imaging lens 22 on the photosensitive surface of the CCD 44. The CCD 44 is connected through a CCD driver 45 to the system controller 40, and the system controller 40 controls the CCD driver 45 to generate a drive signal for the CCD 44. As being driven by the drive signal, the CCD 44 outputs an analog image signal corresponding to the optical image.

The CCD 44 is connected to a correlated double sampling (CDS) circuit 46, which eliminates noises from the image signal and outputs it to an amplifier 47. The amplifier 47 amplifies the image signal with a gain to accord it to a set imaging sensitivity and outputs the amplified image signal to an A/D converter 48.

The A/D converter 48 converts the analog image signal to digital image data and outputs the image data to an image input controller 49. The image input controller 49 is connected through a data bus 50 to a SDRAM 51, to store the image data temporally in the SDRAM 51. Note that the image data written in the SDRAM 51 is low-resolution one for displaying a camera-through image on the LCD 36, and is high-resolution one for recording it on the recording medium 33.

Besides the image input controller 49 and the SDRAM 51, the system controller 40, an image signal processor 52, a compander 53, an LCD driver 54, a media controller 55, an AF detector 56 and an AE detector 57 are connected to the data bus 50. Through the data bus 50, the respective components are controlled by the system controller 40 and exchange data between each other. The image signal processor 52 processes the image data as written in the SDRAM 51 for white-balance correction, gradation-conversion, YC-conversion and the like.

Before the shutter button 31 is operated, the system controller 40 controls the LCD driver 54 to display the camera-through image on the LC 36 based on the processed low-resolution image data. When the shutter button 31 is pressed to the full, the system controller 40 controls the compander 53 to compress the processed image data into JPEG format or other compression format, and controls the media controller 55 to record the compressed image data in the recording medium 33.

To reproduce the image data recorded in the recording media 33, the system controller 40 controls the media controller 55 to read out the image data from the recording media 33, and controls the compander 53 to decompress or expand the image data. Thereafter the system controller 40 controls the LCD driver 54 to display a reproduced image on the LCD 36 based on the decompressed image data.

The AF detector 56 obtains the image data from the SDRAM 51 upon a half-press of the shutter button 31, to integrate high-frequency components of the image data and output the integrated value as an AF evaluation value to the system controller 40, while the focus lens 22c is moving along the optical axis. The system controller 40 drives the focus lens 22c to stop at a position where the AF evaluation value comes to its peak.

The AE detector 57 measures subject brightness from the image data written in the SDRAM 51 upon the half-press of the shutter button 31, to detect an AE evaluation value for optimizing an exposure value and output it to the system controller 40. Based on the AE evaluation value, the system controller 40 decides an aperture size of the stop 22b and an electronic shutter speed of the CCD 44.

The system controller 40 is further connected to the flash projector 24, the supplemental light emitter 26, a sound controller 61 and a decode/encode processor 62. The system controller 40 judges based on the AE evaluation value whether to project light toward the subject, and if it judges it necessary, drives the flash projector 24 to flash.

When the subject is too dark for the AF detector 56 to calculate a valid AF evaluation value, the system controller 40 drives the supplemental light emitter 26 to illuminate the subject so that the AF detector 56 can calculate a valid AF evaluation value. The system controller 40 also controls the supplemental light emitter 26 to blink to send data such as identification data in the form of Morse code to the other digital camera 12.

The sound controller 61 is connected to the microphone 27 and the speaker 28. The sound controller 61 controls the microphone 27 and the speaker 28 to input and output ordinary sound signals. Also the decode/encode processor 62 is connected to the microphone 27 and the speaker 28.

The decode/encode processor 62 is a sound synthesizer that produces a composite sound signal from a sound signal and text data, which are fed from the system controller 40, by encoding the text data through OFDM (orthogonal frequency division multiplex) modulation and superimposing the encoded text data on the sound signal. The decode/encode processor 62 outputs the composite sound signal through the speaker 28. The decode/encode processor 62 is also a data detector that decodes a composite sound signal as obtained through the microphone 27, detects text data superimposed on a sound signal, and outputs the text data to the system controller 40. The speaker 28 has an amplifying function that is provided commonly to the sound controller 61 and the decode/encode processor 62.

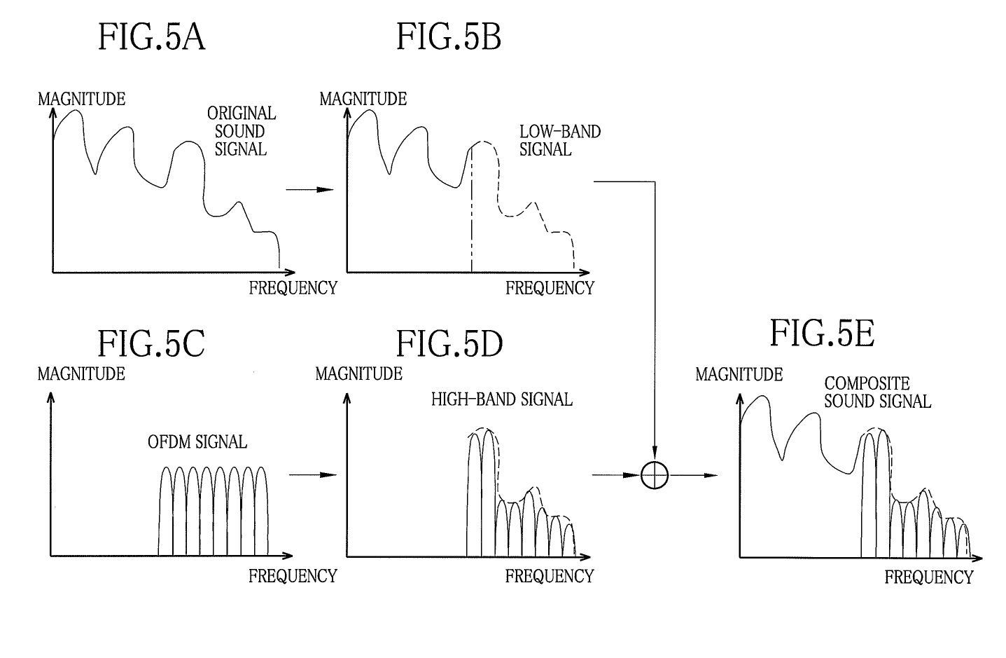

Now the process of superimposing text data on a sound signal in the decode/encode processor 62, called audio OFDM technique, will be described with reference to FIG. 5, wherein the audio OFDM technique permits superimposing data like text data on an ordinary sound or voice without damaging audio frequency components of the original sound.

First, a high frequency band of an original sound signal is cut out to produce a low-band sound signal, as shown in FIGS. 5A and 5B, wherein the original sound signal may be one used in conventional digital cameras, e.g. a sound like a mechanical shutter, a beep, or a sound reproduced with movie pictures.

Next, data to be transmitted on the high frequency band is modified through the OFDM modification, producing an OFDM signal as shown in FIG. 5C. Then the respective OFDM modified sub-carriers are adjusted to a frequency distribution curve of the high-frequency components of the original sound signal, so the signal magnification of the OFDM signal coincides with that of the high frequency band of the original sound signal, as shown in FIG. 5D. Thereafter, the low-band sound signal as shown in FIG. 5B and the OFDM signal after the frequency distribution adjustment, as shown in FIG. 5D, are synthesized to produce a composite sound signal that contains the data without damaging the audio area, i.e. the low frequency band, of the original sound signal, as shown in FIG. 5E.

It is to be noted that an arbitrary format is usable for superimposing data on the sound signal, including text, bit information and other various formats. Since the superimposed data may be taken out from the composite sound signal by carrying out reversed processes to the above described processes, the description of these processes will be omitted.

The digital camera 12 has the same electrical structure as the digital camera 11, so the same description as above applies to the digital camera 12. Hereinafter, one of the digital cameras 11 and 12 will be called the primary camera, and the other will be called the secondary camera.

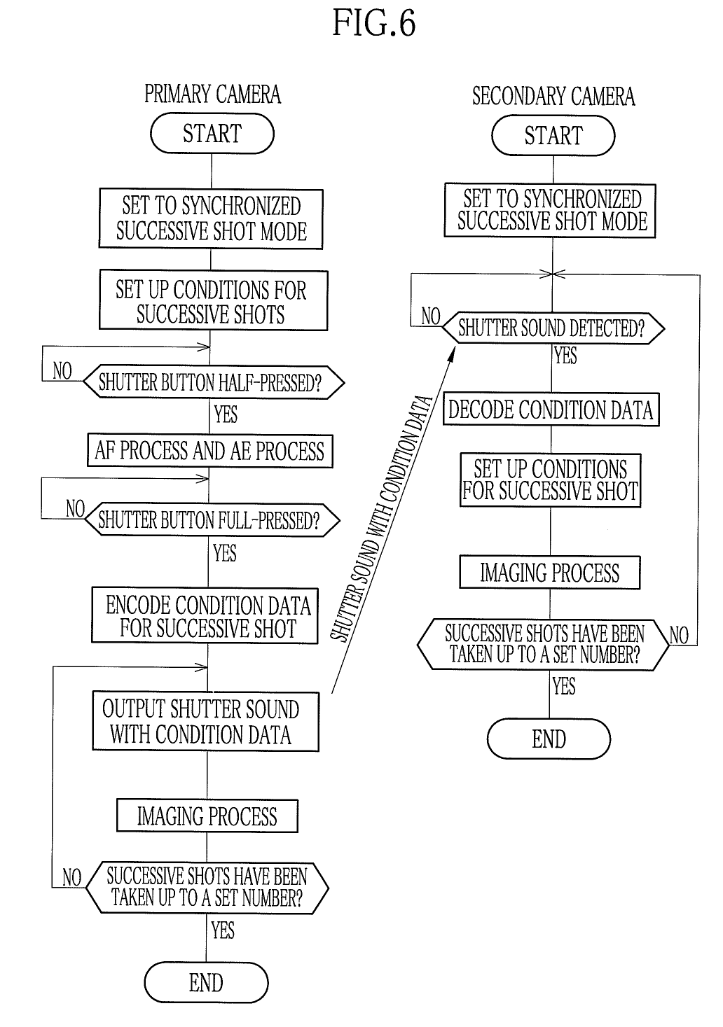

Next, the synchronized successive shot process of the camera system 10 will be described with reference to the flowchart of FIG. 6. First the user operates the operating section 35 of the primary camera to set the system controller 40 in the synchronized successive shot mode, and set up the conditions for the successive shots, including the number of successive shots, the speed of successiveness, the shutter speed, and the aperture value.

After the conditions for successive shots are set up, the system controller 40 checks if the shutter button 31 is pressed halfway, and repeats checking until the shutter button 31 is pressed halfway. When the shutter button 31 is pressed halfway, the system controller 40 controls the AF detector 56 and the AE detector 57 to execute the AF process and the AE process.

Thereafter the system controller 40 checks if the shutter button 31 is fully pressed, and repeats checking until the shutter button 31 is pressed to the full. When the shutter button 31 is pressed fully, the system controller 40 controls the decode/encode processor 62 to make encoding (OFDM modification) of the text data of these conditions, and superimpose the encoded data on a sound signal to produce a composite sound signal. In this example, the composite sound signal is output as a sound like a mechanical lens shutter, hereinafter called a shutter sound.

The decode/encode processor 62 further controls the speaker 28 based on the composite sound signal, to output the shutter sound accompanied with the condition data representative of the set conditions for the successive shots. Thereafter, the system controller 40 controls the respective parts of the primary camera on the basis of the set conditions for the successive shots, to execute the imaging process for one shot.

After the imaging process, the system controller 40 checks whether or not the imaging processes have been executed to take the set number of successive shots. If not, the system controller 40 returns to the process for outputting the shutter sound to repeat the same processes as above. When the imaging processes are accomplished the set number of times, the system controller 40 ends the synchronized successive shot process.

On the other hand, the user also sets the secondary camera to the synchronized successive shot mode. Then the decode/encode processor 62 of the secondary camera checks if the shutter sound with the condition data superimposed thereon is detected, and repeats checking until the shutter sound is detected.

When the shutter sound is detected, the decode/encode processor 62 extracts the OFDM signal from the sound signal detected as the shutter sound. The decode/encode processor 62 decodes the OFDM signal to output the condition data to the system controller 40 of the secondary camera.

Thereafter, the system controller 40 sets up the conditions for the successive shots on the basis of the condition data, and executes the imaging process for one shot. After the imaging process, the system controller 40 checks whether or not the imaging processes have been executed to take the set number of successive shots. If not, the system controller 40 returns to the process for detecting the shutter sound, to repeat the same processes as above. When the imaging processes are accomplished the set number of times, the system controller 40 ends the process for synchronized successive shots.

As describes so far, the secondary camera decodes the OFDM signal that is included in the shutter sound from the primary camera, and sets up the conditions for synchronized successive shots based on the decoded signal. Thus, it is possible to make the primary and secondary cameras execute the successive shot process synchronously with each other, without the need for setting up the conditions for synchronized successive shots in the secondary camera.

In order to synchronize the cameras with each other, it is unnecessary to set up conditions for the communication between them or provide a special communication module, which would be necessary where the cameras are connected through WLAN, Bluetooth or cables. Thus the camera system of the above embodiment can accomplish the synchronized successive shot process with the above-described simple configuration, saves the production cost and eases the operational work.

Although the user sets both the primary and secondary cameras to the synchronized successive shot mode in the above embodiment, it is possible to configure the cameras so that they can execute the synchronized successive shot process if only the user sets the primary camera to the synchronized successive shot mode. The following description relates to such an embodiment.

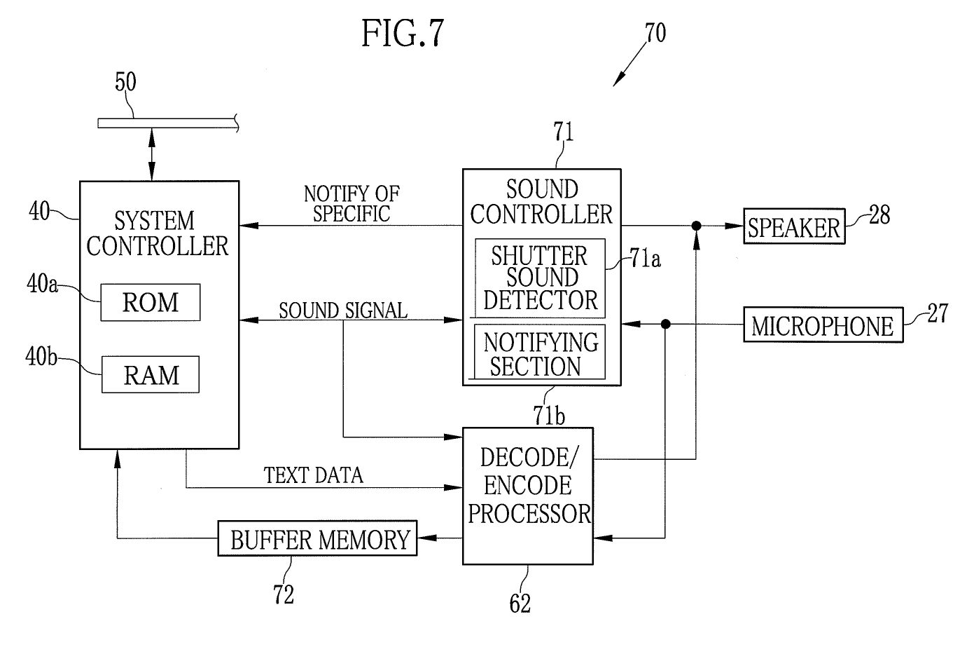

As shown in FIG. 7, a digital camera 70 is provided with a system controller 40, a sound controller 71, a decode/encode processor 62, a microphone 27, a speaker 28 and a buffer memory 72 as a storage device for storing condition data defining conditions for successive shots temporarily.

Dislike the sound controller 61 of the above embodiment, the sound controller 71 is provided with a shutter sound detector 71a and a notifying section 71b. The shutter sound detector 71a picks up sound data each time it is output from the microphone 27, and judges whether the sound data represent a specific shutter sound or not. When the shutter sound detector 71a detects the specific shutter sound, the notifying section 71b notifies a system controller 40 of the detection of the specific shutter sound, to interrupt the system controller 40 for the synchronized successive shot mode. The specific shutter sound is thus detected faster than the decoding process, so the successive shot process in the secondary camera is synchronized more precisely with the successive shot process of the primary camera.

The buffer memory 72 is connected between the system controller 40 and the decode/encode processor 62. The decode/encode processor 62 writes the buffer memory 72 with the condition data for successive shots each time it is detected by decoding the composite sound signal. Thus, the condition data is caught by the secondary camera without fail any time the data is sent from the primary camera. Note that the buffer memory 72 may be omitted and the condition data may be temporarily stored in a SDRAM 51.

The system controller 40 reads out the condition data from the buffer memory 72 when it is notified of the detection of the specific sound, and sets up the conditions to execute the synchronized successive shot process.

Note that other components of the digital camera 70 than those illustrated in FIG. 7 are equivalent to the components of the digital camera 11, so they are omitted from the drawing to avoid complication. Among the components illustrated in FIG. 7, the same components are designated by the same reference numerals as in FIG. 4, so the detailed description of these components will be omitted.

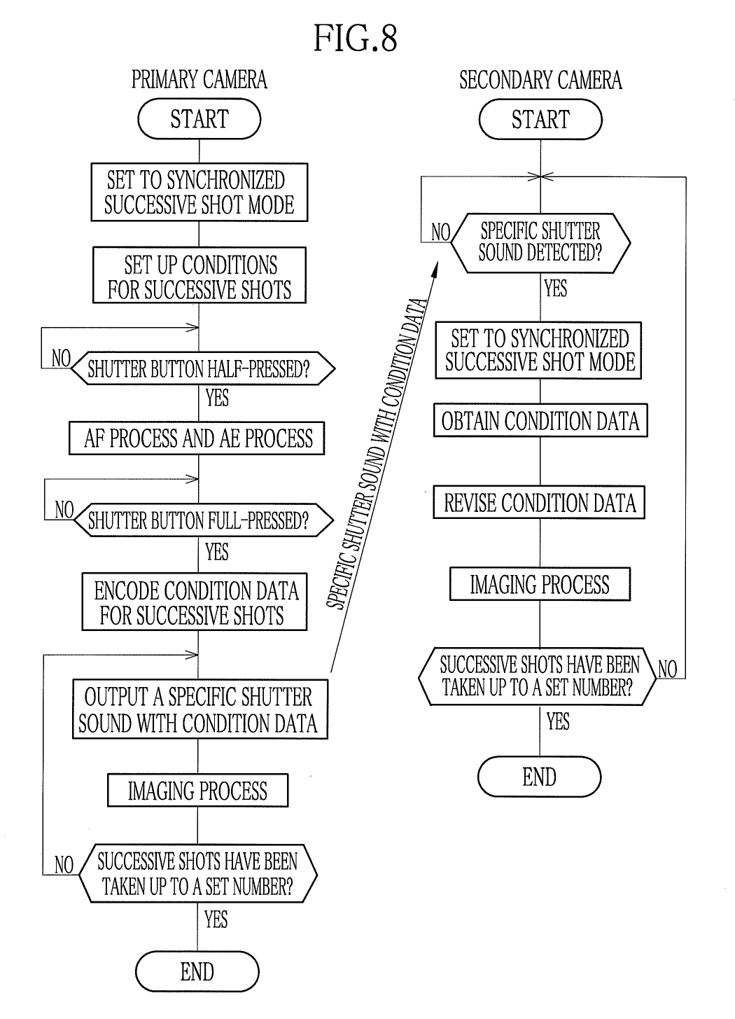

Now the synchronized successive shot process using the digital cameras 70 as primary and secondary cameras will be described with reference to the flowchart of FIG. 8, wherein the procedures from the start to the checking of whether the shutter button is fully pressed or not are equal to those described with reference to FIG. 6, so the description of these steps will be omitted.

When the shutter button 31 of the primary camera is fully pressed, the system controller 40 of the primary camera controls the decode/encode processor 62 to encode the condition data for successive shots and superimposes it on sound data representative of the specific shutter sound that is different from a shutter sound used in an ordinary imaging mode, there by to produce a composite sound signal.

Based on the composite sound signal, the decode/encode processor 62 controls the speaker 28 to output the specific shutter sound accompanied with the condition data. Thereafter, the system controller 40 controls the respective components based on the condition data, to execute the imaging process for one shot.

After the imaging process, the system controller 40 checks whether or not the imaging processes have been executed to take the set number of successive shots. If not, the system controller 40 returns to the process for outputting the shutter sound to repeat the same processes as above. When the imaging processes are accomplished the set number of times, the system controller 40 ends the process for synchronized successive shots.

On the other hand, the system controller 40 of the secondary camera checks if the specific shutter sound is detected, by checking the notification from the shutter sound notifying device 71b. The system controller 40 repeats checking until the specific shutter sound is detected.

When the specific shutter sound is detected, the system controller 40 sets the secondary camera to the synchronized successive shot mode, and reads out the condition data from the buffer memory 72 and revise it. After revising the condition data, the system controller 40 controls the respective components based on the revised condition data, to execute the imaging process for one shot.

After the imaging process, the system controller 40 checks whether or not the imaging processes have been executed the set number of times. If not, the system controller 40 returns to the process for detecting the specific shutter sound to repeat the same processes as above. When the imaging processes are accomplished the set number of times, the system controller 40 ends the process for synchronized successive shots.

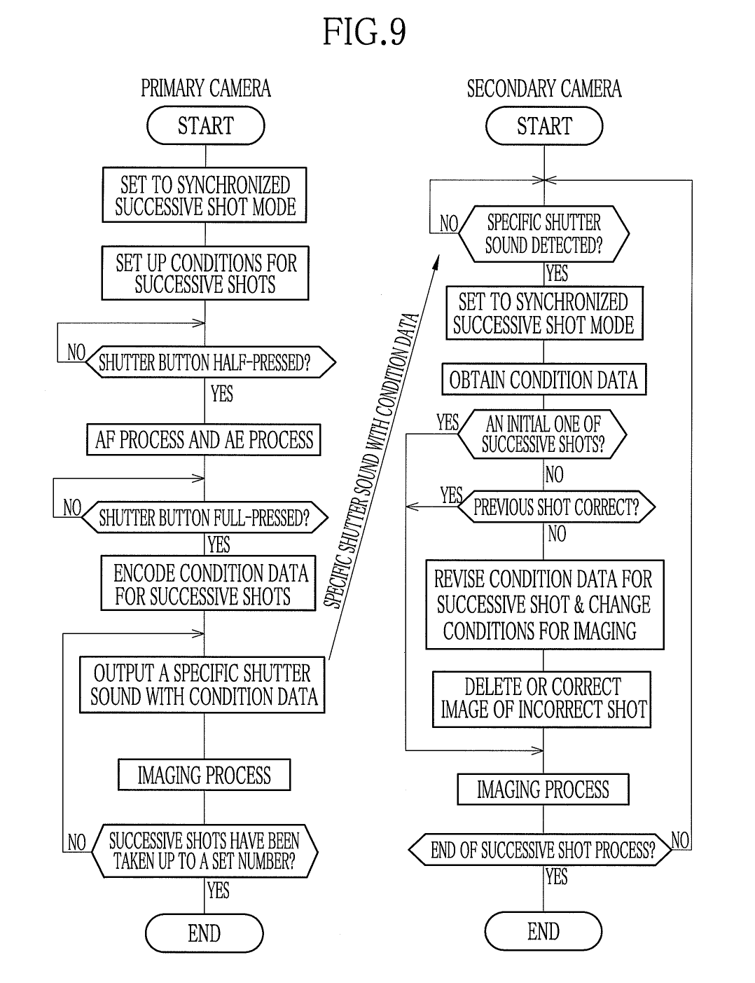

FIG. 9 illustrates a synchronized successive shot process according to another embodiment, wherein the result of the previous imaging process is fed back to judge whether the previous shot was correct or not. The procedures of the synchronized successive shot process in the primary camera are equal to the embodiment shown in FIG. 8, so the description about the primary camera will be omitted, but only procedures in the secondary camera will be described. Note that the primary and secondary cameras are assumed to have the same structure as the digital camera 70 in this embodiment.

The system controller 40 of the secondary camera checks if the specific shutter sound is detected, and repeats checking until the specific shutter sound is detected. When the specific shutter sound is detected, the system controller 40 sets the secondary camera to the synchronized successive shot mode, and reads out condition data for successive shots from the buffer memory 72.

After obtaining the condition data, the system controller 40 determines whether the imaging process to execute next is for an initial one of a series of successive shots. If the imaging process is for the initial shot, the system controller 40 controls the respective components based on the condition data obtained from the buffer memory 72, to make the imaging process for the initial shot. After the imaging process, the system controller 40 checks whether the synchronized successive shot process is accomplished or not.

When the system controller 40 determines that the imaging process to execute next is not for the initial shot, the system controller 40 refers to such condition data as used for the previous shot, to judge whether the previous shot was correct or not. Judging the previous shot to be correct, the system controller 40 controls the respective components based on the previous condition data, to execute the imaging process for one shot. Thereafter the system controller 40 checks whether the synchronized successive shot process is accomplished or not.

If the system controller 40 judges that the previous shot was incorrect, the system controller 40 revises the condition data for successive shots with one obtained from the buffer memory 72, and changes conditions for imaging. The system controller 40 also delete or correct image data that was taken by the incorrect shot. Thereafter, the system controller 40 execute the imaging process for one shot, and then checks whether the synchronized successive shot process is accomplished or not.

To judge whether the synchronized successive shot process is accomplished or not, the system controller 40 compares the set or required number of successive shots with the number of already taken shots. If it is judged that the number of taken shots does not reach the required number and thus the successive shot process is not accomplished, the sequence returns to the procedure for checking whether the specific shutter sound is detected or not, and the following procedures are carried out again. If judged to be accomplished, the synchronized successive shot process is terminated.

According to the just-described embodiment, the specific shutter sound is used as a trigger for timing the successive shots and the decoding process is executed for each shot, which make it possible to change the conditions for successive shots. Since the image data taken through the incorrect imaging process is deleted or corrected, this embodiment prevents unnecessary image data from being accumulated in a recording medium 33.

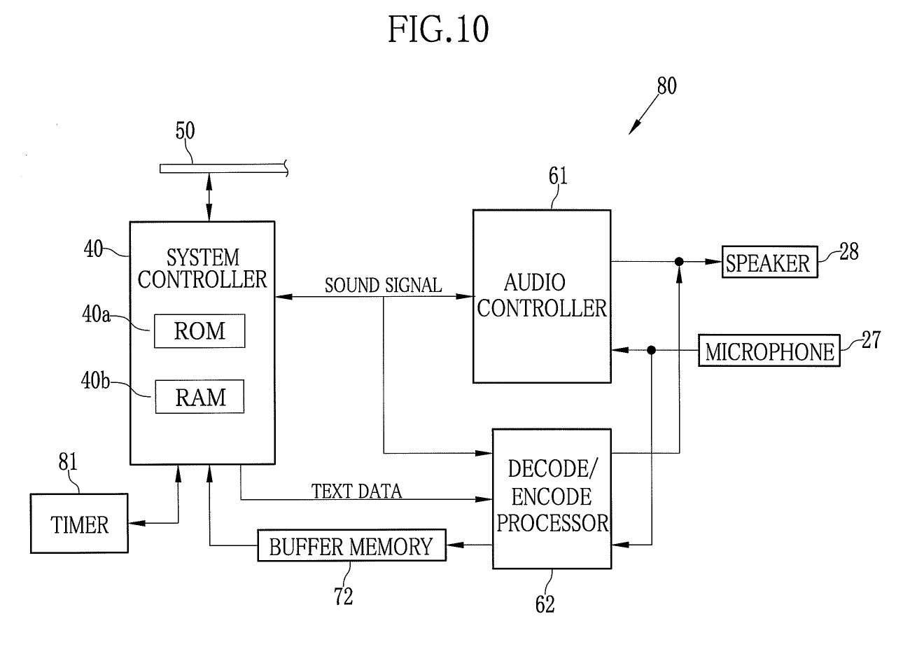

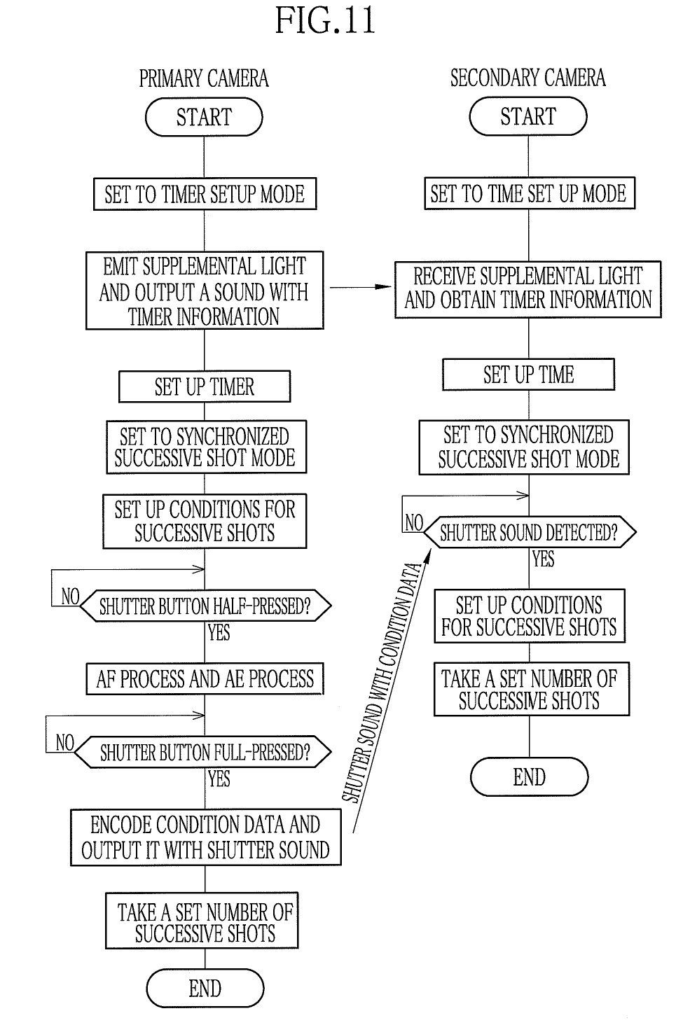

Next another embodiment will be described with reference to FIGS. 10 and 11, wherein a digital camera 80 is provided with a timer 81 that is connected to a system controller 40 so as to output a timing signal to respective components in order to control timing of operations of these components. Otherwise, the digital camera 80 has the same structure as the digital camera 11, so the detailed description of the respective components will be omitted.

In order to execute a timing correction process in a camera system consisting of primary and secondary digital cameras 80, the cameras are positioned to face to each other, and a system controller 40 of the primary camera controls the timer 81 and a supplemental light emitter 26, so that the supplemental light emitter 26 blinks at a specific timing defined by the timing signal from the timer 81 and at an appropriate light intensity. Simultaneously, the primary camera outputs a shutter sound with timer information from a speaker 28. The timer information includes information on a delay time for the timer 81 and the supplemental light emitter 26 of the primary camera to start lighting, basic clock information etc. Then the primary camera corrects the timing of the timer 81, the timing of outputting the shutter sound and the timing of each shot.

On the other hand, a system controller 40 of the secondary camera controls a CCD 44 to detect the blink of the supplemental light emitter 26 of the primary camera, and adjusts the timer 81 of the secondary camera to the same timing as the primary camera. Furthermore, based on the timer information from the primary camera and the information on the delay time of the supplemental light emission from the secondary camera, the system controller 40 adjusts the timing of detecting the shutter sound and the timing of each shot. For example, the timing of the timer 81 of the secondary camera is adjusted to coincide with that of the primary camera in the order of millisecond or microsecond.

The synchronized successive shot process using the digital cameras 80 as the primary and secondary cameras will be described with reference to the flowchart of FIG. 11. First the user operates the operating section 35 of the primary camera to select a timer setup mode. As being set to the time setup mode, the system controller 40 controls the supplemental light emitter 26 to blink at the specific timing, and outputs the sound with the timer information to setup the timer 81.

Thereafter when the primary camera is set to the synchronized successive shot mode, the system controller 40 sets up the conditions for successive shots, and checks if the shutter button 31 is pressed halfway. The system controller 40 repeats checking until the shutter button 31 is pressed halfway. When the shutter button 31 is pressed halfway, the system controller 40 controls an AF detector 56 and an AE detector 57 to execute the AF process and the AE process.

Thereafter the system controller 40 checks if the shutter button 31 is fully pressed, and repeats checking until the shutter button 31 is pressed to the full. When the shutter button 31 is pressed fully, the system controller 40 controls the decode/encode processor 62 to make encoding (OFDM modification) of the data of these conditions, and superimpose the encoded data on a sound signal to produce a composite sound signal. In this example, the sound signal is output as a shutter sound. The system controller 40 starts the process for successive shots when the set time comes, and ends the synchronized successive shot process after taking the set number of successive shots.

On the other hand, the secondary camera is also set to the timer setup mode. Then the system controller 40 of the secondary camera controls the CCD 44 to receive the supplemental light, and also controls the decode/encode processor 62 to decode the shutter sound to obtain the timer information. On the basis of the specific timing transmitted by the supplemental light and the timer information, the system controller 40 sets up the timer 81 of the secondary camera.

The secondary camera is set to the synchronized successive shot mode after the setup of the timer 81, and the decode/encode processor 62 checks if the shutter sound is detected, and repeats checking until the specific shutter sound is detected. When the shutter sound is detected, the decode/encode processor 62 decode the sound signal of the shutter sound to output the condition data to the system controller 40. Then, the system controller 40 sets up the conditions for successive shots and controls the respective components to execute the successive shot process from the time set to start the successive shots. After taking the set number of successive shots, the system controller 40 terminates the synchronized successive shot process.

In the above embodiment, the timer 81 is specifically provided in each digital camera. Instead of the timer 81, a real time clock (RTC) is usable. In that case, since data of the RTC is modified for successive shots, past data should be corrected and rewritten in the RTC after the successive shot process is accomplished.

Although the supplemental light emitter 26 is caused to blink on setting the timer 81 in the above embodiment, it is possible to use another device, e.g. the flash projector 24 or a tally light in place of the supplemental light emitter 26, and cause it to blink with an appropriate intensity at specific timing.

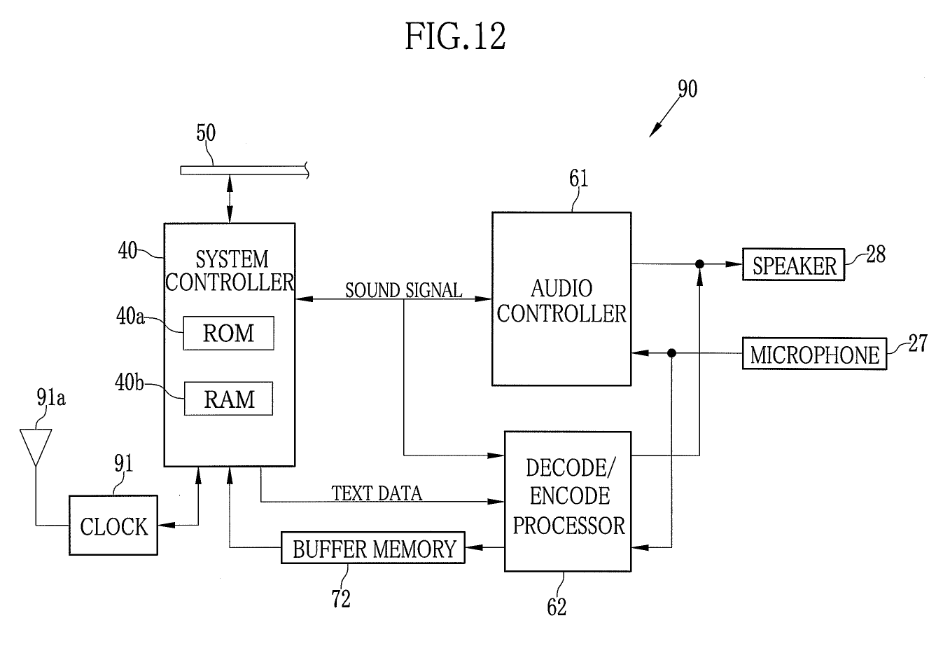

FIG. 12 shows a digital camera 90 of a camera system according to another embodiment. Instead of the timer 81 of the digital camera 80, the digital camera 90 is provided with a clock section 91. The clock section 91 is constituted of a wave clock having an antenna 91a, so it can continually output exact time information, wherein the time information indicates the time of starting a series of successive shots and the timings of successive shots. Based on the time information from the clock 91, the digital camera 90 synchronizes the timing of successive shots with other digital cameras 90 of the camera system. Otherwise the digital camera 90 is structured the same as the digital camera 80, so the same components are designated by the same reference numerals and the detailed description of these components will be omitted.

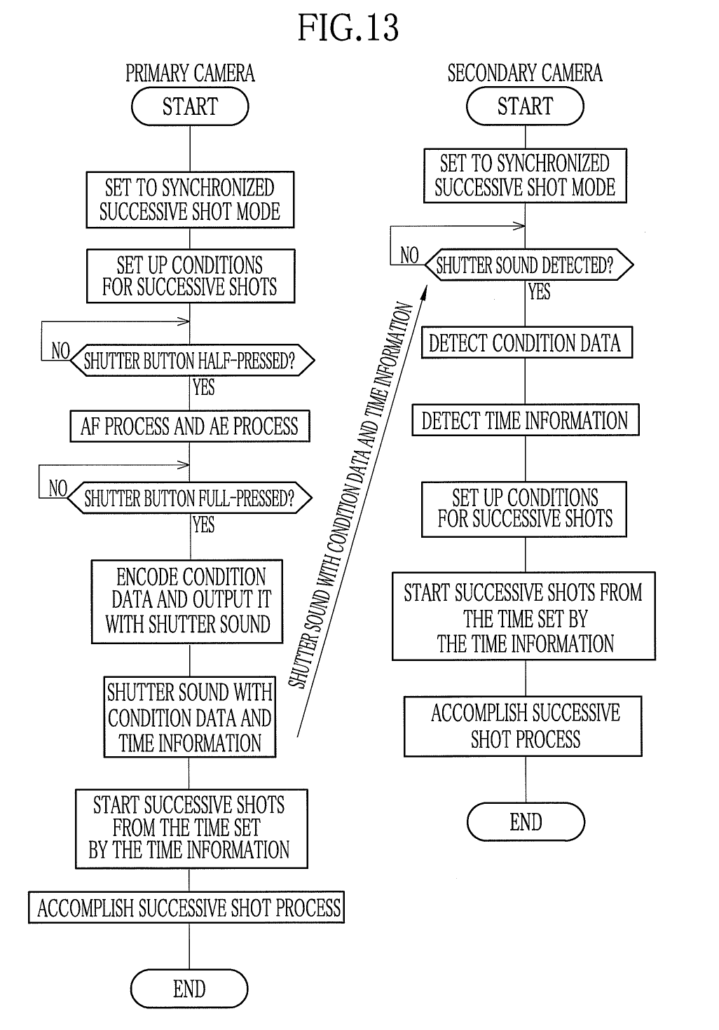

A synchronized successive shot process using the digital cameras 90 as primary and secondary cameras will be described with reference to the flowchart of FIG. 13, wherein the procedures from the start to the checking of whether the shutter button is fully pressed or not are equal to those described with reference to FIG. 9, so the description of these steps will be omitted.

When a shutter button 31 of the primary camera is fully pressed, a system controller 40 of the primary camera controls a decode/encode processor 62 to encode condition data for successive shots, including the time information, into an OFDM signal, and superimposes the OFDM signal on a sound signal representative of a shutter sound, producing a composite sound signal. The composite sound signal is output as the shutter sound through a speaker 28.

Thereafter the system controller 40 controls the respective components on the basis of the condition data including the time information, thereby to start the successive shot process from the set starting time and then end the synchronized successive shot process when the successive shots have been taken up to the set number.

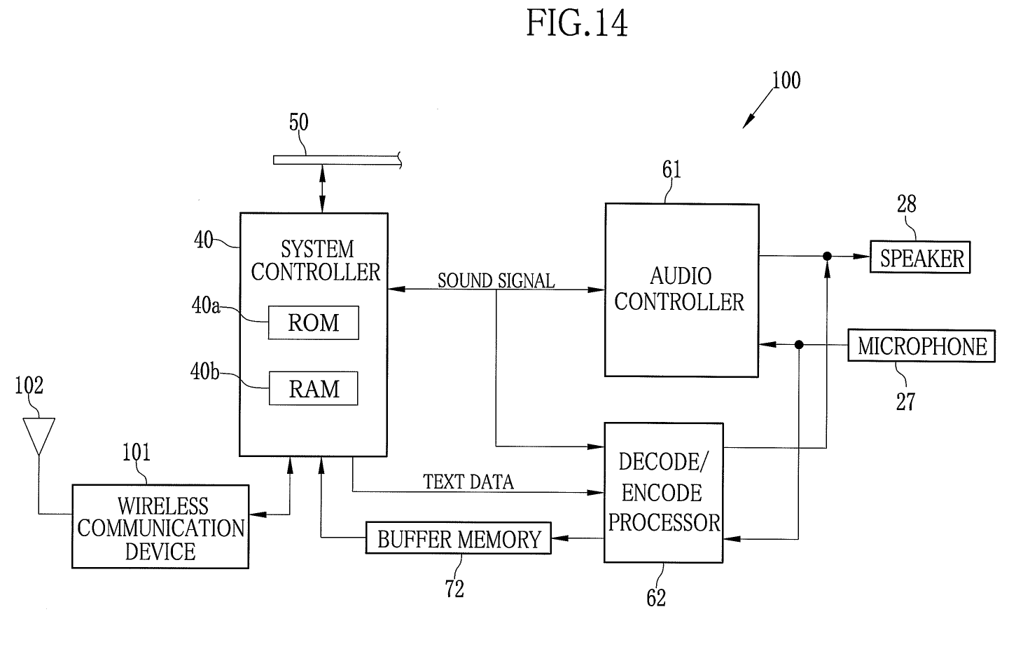

Next a further embodiment will be described with reference to FIG. 14, wherein the OFDM technique is applied to setting up wireless communication, e.g. wireless LAN, Bluetooth etc. A digital camera 100 is provided with a wireless communication device 101, which is for example a wireless LAN interface connected to an antenna 102. The wireless communication device 101 controls wireless communication with other digital cameras through the antenna 102. Otherwise the digital camera 100 is structured the same as the digital camera 90, so the same components are designated by the same reference numerals and the detailed description of these components will be omitted.

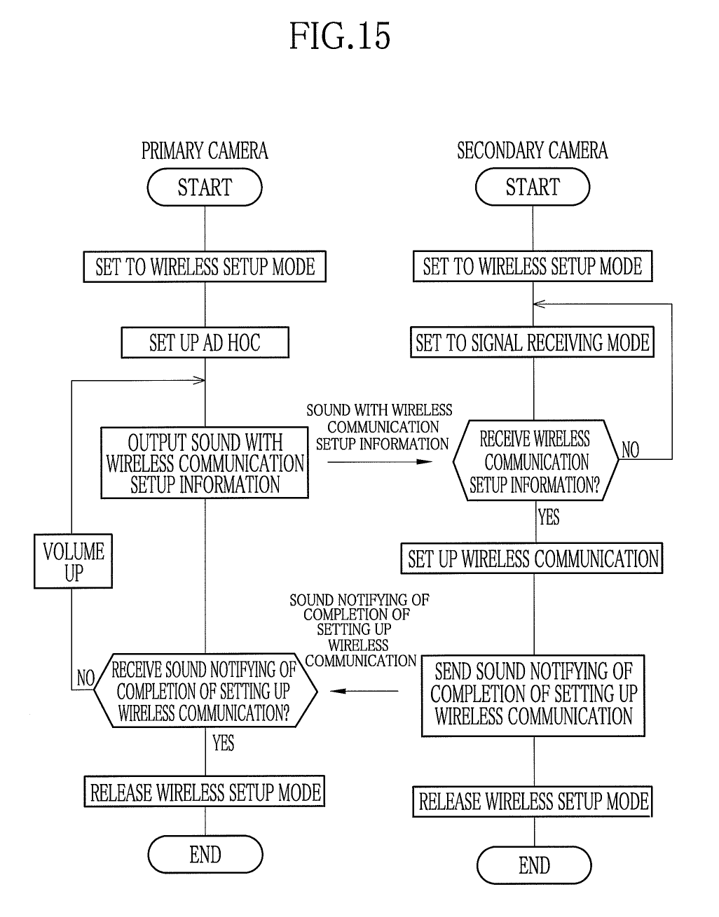

The following description will relate to a case of setting up ad-hoc wireless communication that is a way of direct communication without any wireless LAN access point between machines. The wireless communication setup process using the digital cameras 100 as primary and secondary cameras will be described with reference to the flowchart of FIG. 15.

First the primary and secondary cameras are placed as close to each other as possible. Through an operating section 35, the primary camera is set to a wireless setup mode, wherein a system controller 40 automatically sets up the ad-hoc communication at random, and stores already setup contents in a temporary memory, like a RAM 40b.

Thereafter the system controller 40 controls a decode/encode processor 62 to encode wireless communication setup information into an OFDM signal, and superimposes the OFDM signal on a sound signal representative of a shutter sound or the like, to produce a composite sound signal. The composite sound signal is output through a speaker 28 to send the wireless communication setup information, hereinafter called simply the wireless communication setup information, to the secondary camera.

Thereafter the system controller 40 of the primary camera checks whether the wireless communication device 101 receives a notice of completion of setting up wireless communication from the secondary camera. If not, the system controller 40 controls the decode/encode processor 62 to turn up the sound volume, and returns to the procedure for sending out the wireless communication setup information, to repeat the same procedures as above. Upon receipt of the notice of completion of setting up wireless communication, the system controller 40 releases the wireless setup mode, to end the wireless communication setup process.

On the side of the secondary camera, the user operates an operating section 35 to set the secondary camera to the wireless setup mode and thereafter selects a signal receiving mode. Then a system controller 40 sets a wireless communication device 101 to a signal receiving mode. Thereafter the system controller 40 controls the decode/encode processor 62 to check if it receives the wireless communication setup information. If not, the system controller 40 returns to the procedure of setting the signal receiving mode and repeats the same procedures as above.

When it is determined that the wireless communication setup information is received, the system controller 40 obtains this information after being decoded through the decode/encode processor 62. On the basis of the obtained information, the system controller 40 sets up the wireless communication device 101. Then the system controller 40 controls the wireless communication device 101 to send out the notice of completion of setting up wireless communication to the primary camera, and releases the wireless setup mode to end the wireless setup process in the secondary camera.

Since the wireless communication between the primary and secondary cameras comes to be unnecessary at the end of the wireless communication between them, the wireless communication are set back to the past setup conditions.

In the above embodiment, the OFDM signal as the encoded information is superimposed on the sound signal that represents a sound like a lens shutter, a beep or the like. The present invention is not limited to this embodiment, but the ODFM signal may be superimposed on a sound signal that represents user's voice that is previously registered in the camera.

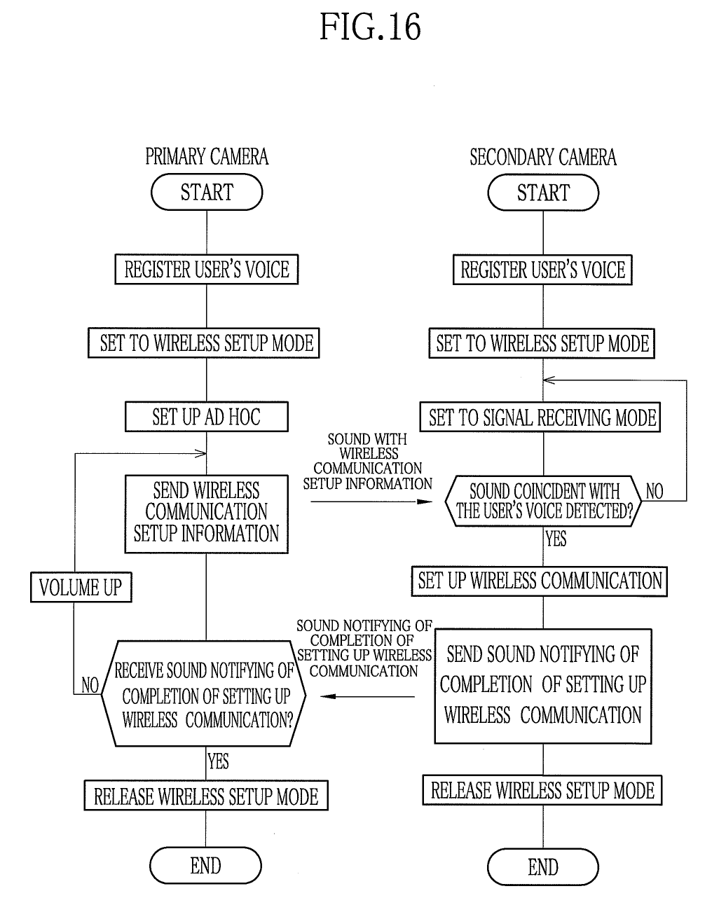

FIG. 16 shows a wireless setup process in the digital cameras 100, wherein wireless communication setup information is superimposed on a sound signal of previously registered user's voice. First the system controller 40 of the primary camera controls the sound controller 61 to obtain data of the voice through a microphone, and stores the voice data in the RAM 40a or the recording medium 33.

Thereafter when the primary camera is set to a wireless setup mode, the system controller 40 controls the decode/encode processor 62 to encode wireless communication setup information into an OFDM signal, and superimposes the OFDM signal on the sound signal representative of the user's voice, to produce a composite sound signal. The composite sound signal is output through a speaker 28 to send the wireless communication setup information to the secondary camera. Thereafter the primary camera carries out the same procedures as described with reference to FIG. 15, so the detailed description is omitted.

On the side of the secondary camera, the system controller 40 controls the sound controller 61 to catch the user's voice through the microphone 27 and stores it in the RAM 40a or the recording medium 33. Thereafter when the secondary camera is set to the wireless setup mode and then the signal receiving mode, the system controller 40 controls the sound controller 61 to check if it receives the composite sound signal representative of a voice that coincides with the voice data stored in the RAM 40a.

If not, the system controller 40 returns to the procedure of setting the secondary camera to the receiving mode and repeats the same procedures until the sound signal coincident with the stored voice data is received. When the sound signal coincident with the stored voice data is received, the system controller 40 obtains the wireless communication setup information by decoding the sound signal. On the basis of the obtained information, the system controller 40 sets up the wireless communication device 101. Thereafter the primary camera carries out the same procedures as described with reference to FIG. 15, so the detailed description is omitted.

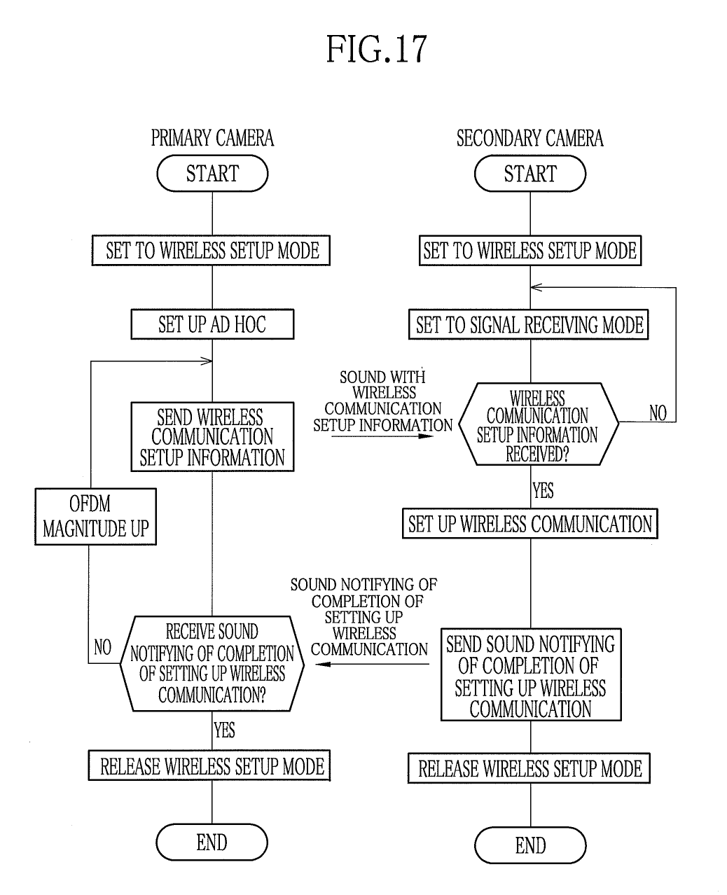

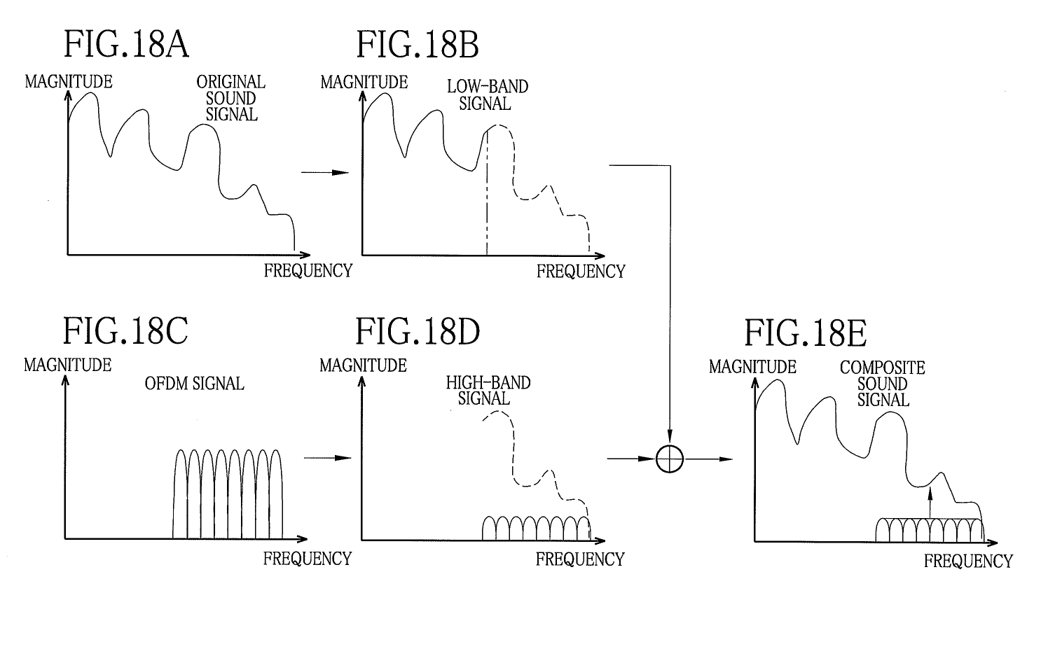

In the embodiments of FIGS. 15 and 16, the primary camera turns up the volume of the sound from the speaker 28 if it does not receive the notice of completion of setting up wireless communication from the secondary camera. It is also possible to turn up the magnitude of the decoded (OFDM modified) data instead, as shown in FIGS. 17 and 18.

According to this embodiment, the system controller 40 of the primary camera controls the decode/encode processor 62 to turn up the magnitude of the OFDM signal as shown in FIG. 18. Other procedures are the same as the wireless setup process described with reference to FIG. 17, so the detailed description will be omitted.

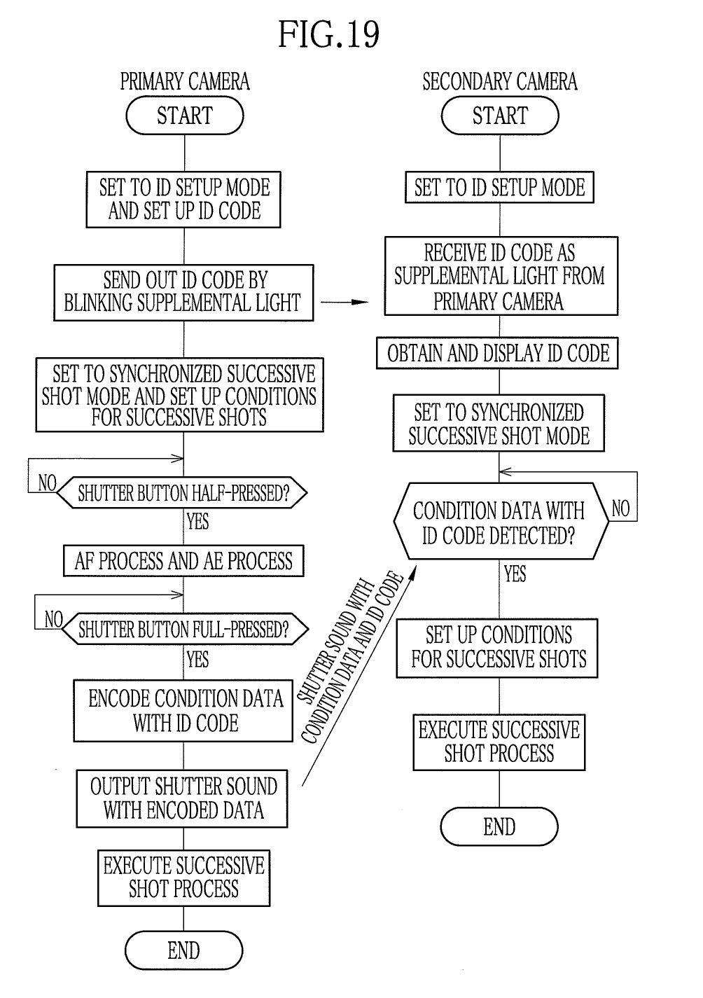

By gradually turning up the magnitude of the OFDM modified fragment, i.e. the data magnitude, during the audio OFDM communication, the data is sent to only those cameras which are placed in a near range around the primary camera, whereas the sound volume from the speaker 28 is kept unchanged. The OFDM data serves as an ID for wireless communication. It is possible to add the OFDM data as an ID to the above-described condition data for successive shots, or cipher the condition data for successive shots correspondingly to the ID, so that the synchronized successive shot process may be executed in specified cameras exclusively, as set forth below with reference to FIGS. 19 to 22. Note that camera systems of the following embodiments may be constituted of at least a primary camera and a secondary camera, which have the same structure as shown in FIG. 4, so the details of the cameras will be omitted.

In a synchronized successive shot process according to the embodiment of FIG. 19, the user sets a primary camera to an ID setup mode, so a system controller 40 sets up an ID code that the user may be input through an operating section 35 or the system controller 40 may produce automatically.

After setting up the ID code, the system controller 40 controls the supplemental light emitter 26 to blink at an appropriate intensity and timing to send out the ID code in Morse.

Thereafter the primary camera is set to the synchronized successive shot mode, and conditions for successive shots are designated. Then the system controller 40 checks if a shutter button 31 is pressed halfway, and repeats checking until the shutter button 31 is pressed halfway. When the shutter button 31 is pressed halfway, the system controller 40 executes the AF process and the AE process.

Thereafter the system controller 40 checks if the shutter button 31 is fully pressed, and repeats checking until the shutter button 31 is pressed to the full. When the shutter button 31 is pressed fully, the system controller 40 controls a decode/encode processor 62 to encode data of the conditions for successive shots with the ID code, and superimpose the encoded data on a sound signal to produce a composite sound signal.

On the basis of the composite sound signal, the decode/encode processor 62 controls a speaker 28 to output a shutter sound accompanied with the ID code and the condition data. Thereafter, on the basis of the conditions for successive shots, the system controller 40 controls respective components to execute the synchronized successive shot process.

On the other hand, a secondary camera is set to the ID setup mode. Thereafter when the secondary camera receives the ID code as the light from the supplemental light emitter 26 of the primary camera, a system controller 40 of the secondary camera gets the ID code and controls an LCD driver 54 to display the ID code on an LCD 36.

Thereafter when the secondary camera is set to the synchronized successive mode, the system controller 40 controls the decode/encode processor 62 to check if the condition data with the ID code is detected, and repeat checking until the condition data with the ID code is detected. If the detected ID code does not coincide with the preset ID code, the decode/encode processor 62 repeats checking.

When the condition data with the ID code is detected and the ID code coincides with the preset ID code, the decode/encode processor 62 outputs the condition data to the system controller 40. On the basis of the condition data, the system controller 40 controls the respective components to execute the successive shot process.

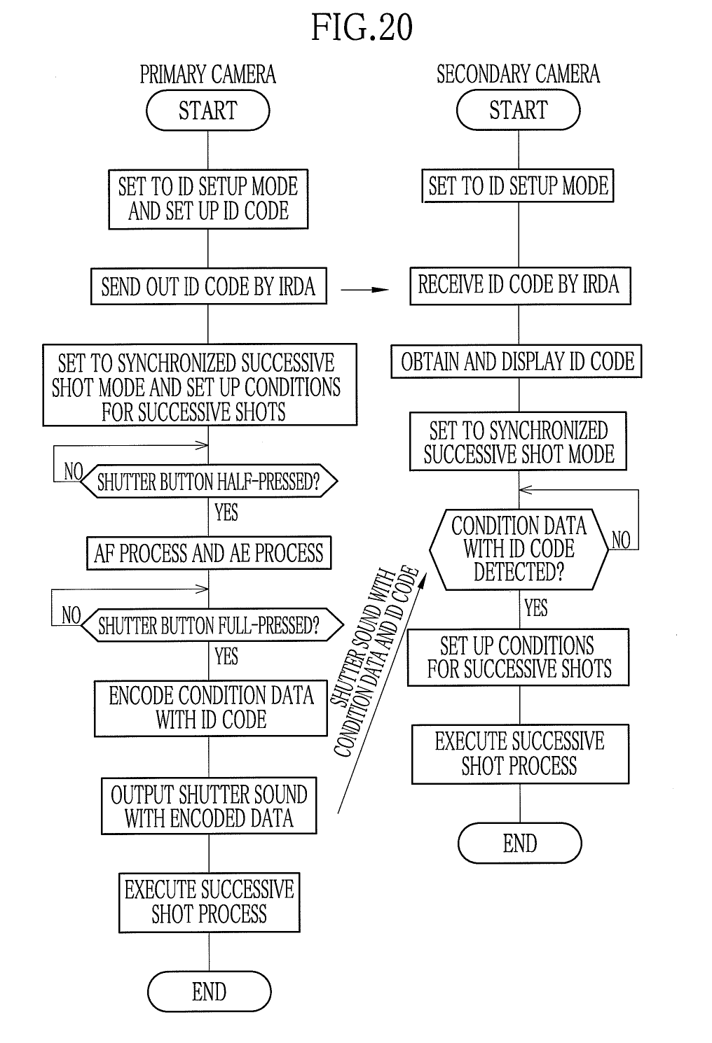

In the above embodiment, the ID code is sent to other cameras by blinking the supplemental light emitter, the ID code may be sent by blinking a flash projector or a tally light. Furthermore, the ID code may also be sent by use of IrDA (infrared data association), as shown in FIG. 20, in the same way as for the embodiment of FIG. 19. Instead of IrDA, RFID (radio frequency identification) is usable for sending the ID code.

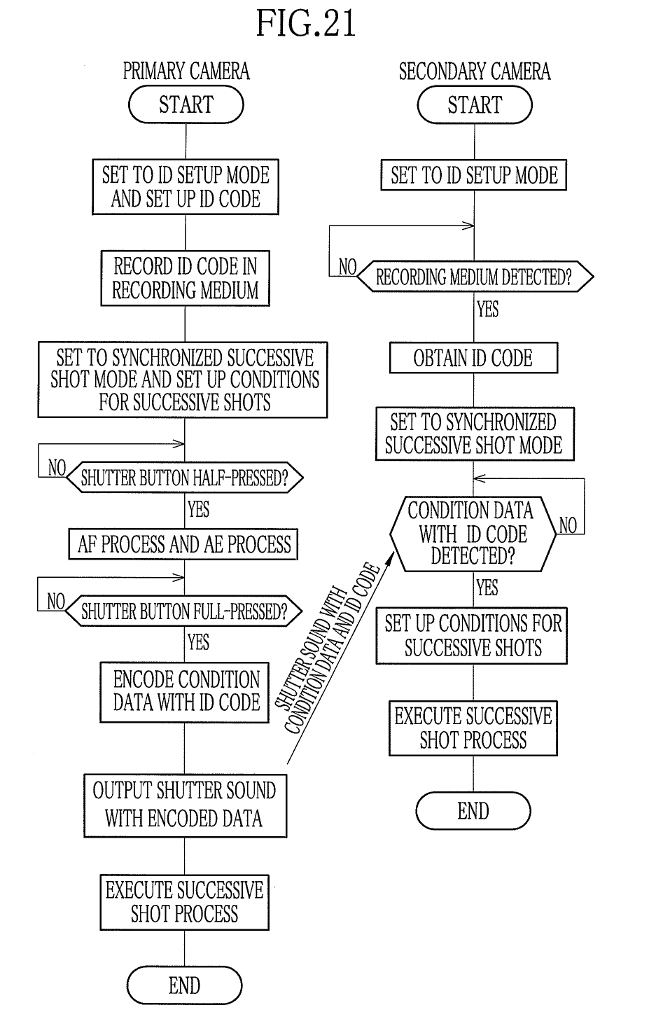

Next another embodiment of synchronized successive shot process will be described with reference to FIG. 21, wherein the ID code is forwarded from a primary camera to a secondary camera through a recording medium 33. First the primary camera is set to the ID setup mode and the ID code is designated. Then a system controller 40 controls a media controller 55 to record the ID code in the recording medium 33. The ID code may be input by the user through an operating section 35, or may be produced automatically. After recording the ID code in the recording medium 33, the system controller 40 executes the synchronized successive shot process in the same way as described above, so the further description of the synchronized successive shot process in the primary camera will be omitted.

On the other hand, the secondary camera is also set to the ID setup mode. Then a system controller 40 of the secondary camera checks whether the recording medium 33 having the ID code written therein is detected or not, and repeat checking until it detects the recording medium 33. When the recording medium 33 is detected, the system controller 40 controls a media controller 55 of the secondary camera to read out the ID code. Thereafter the secondary camera executes the synchronized successive shot process in the same way as described above, so the further description of the synchronized successive shot process in the secondary camera will be omitted.

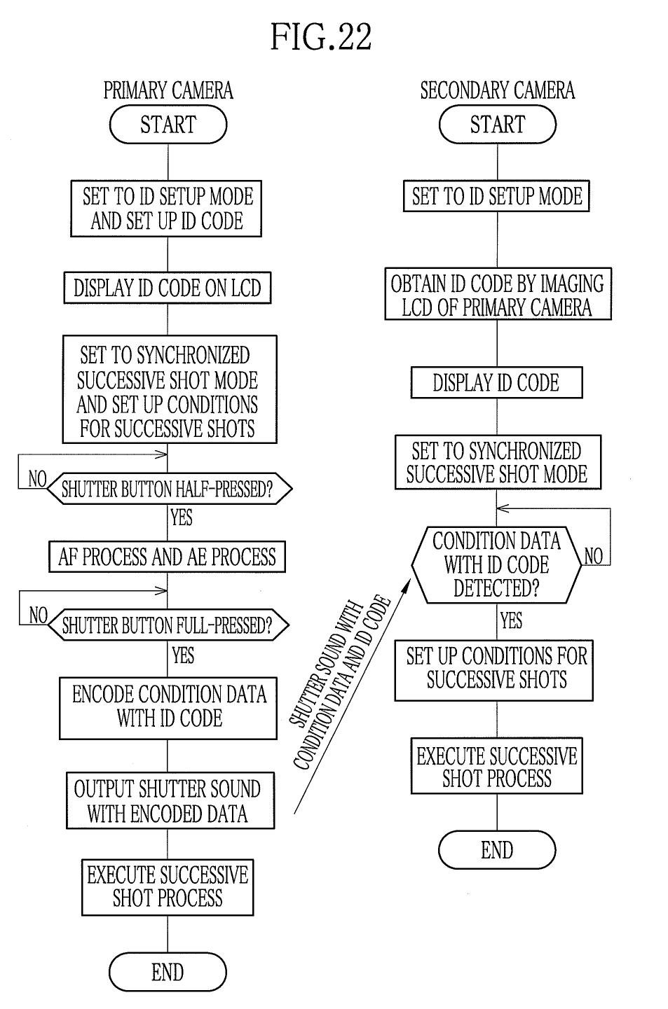

FIG. 22 illustrates still another embodiment of synchronized successive shot process, wherein the ID code is forwarded from a primary camera to a secondary camera through an LCD 36. First the primary camera is set to the ID setup mode and the ID code is designated. Then a system controller 40 controls an LCD driver 54 to display the ID code on the LCD 36. The ID code may be input by the user through an operating section 35, or may be produced automatically. Thereafter the primary camera executes the synchronized successive shot process in the same way as described above, so the further description of the synchronized successive shot process in the primary camera will be omitted.

On the other hand, the secondary camera is also set to the ID setup mode. Then a system controller 40 of the secondary camera drives a CCD 44 to pick up an image displayed on the LCD 36 of the primary camera, and thus obtains the ID code. The system controller 40 drives an LCD driver 54 to display the ID code on an LCD 36 of the secondary camera. Thereafter the secondary camera executes the synchronized successive shot process in the same way as described above, so the further description of the synchronized successive shot process in the secondary camera will be omitted.

As described so far, the secondary camera gets the ID code from the primary camera by imaging the ID code displayed on the LCD of the primary camera. This method is not only useful for improving security of data communication through the audio OFDM, but also applicable to exchanging the ID code in various data communication methods like wireless LAN and WiMAX. The ID code may be a two-dimensional bar code, a three-dimensional bar code, arbitrary numerals, alphabets and/or signs, and may use any data format.

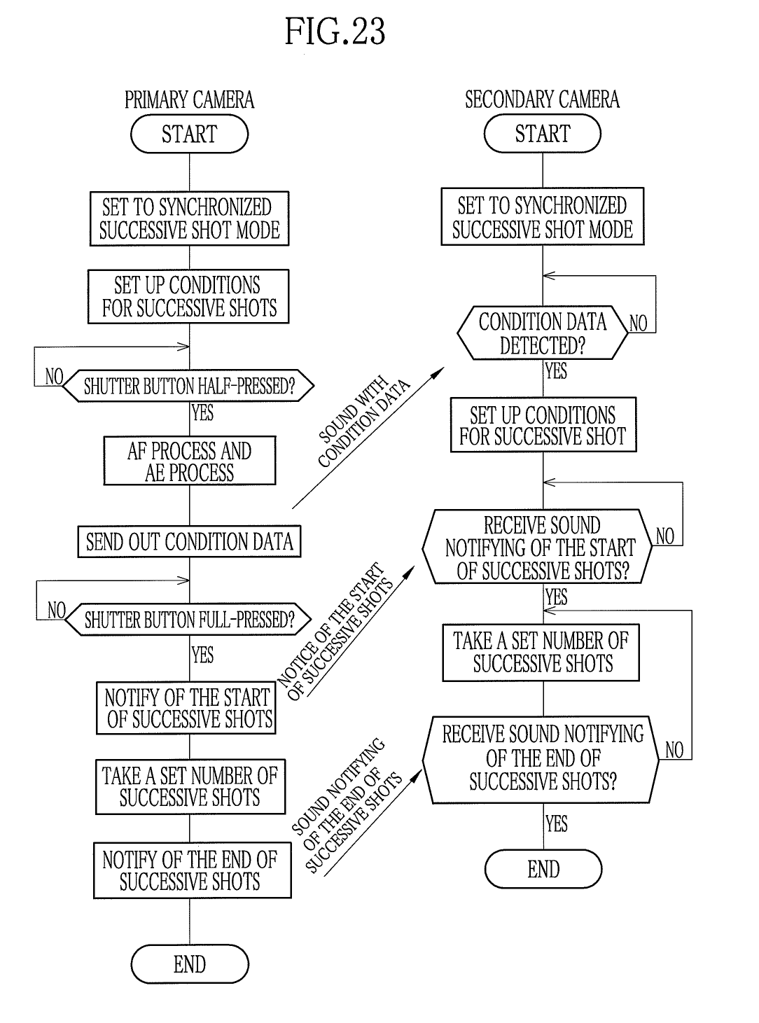

Although the condition data for successive shots is sent out upon the shutter button being pressed to the full in the above embodiments, it is alternatively possible to send out the condition data upon the shutter button being pressed halfway, as set forth below with reference to FIG. 23.

After the conditions for successive shots are designated in a synchronized successive shot mode, a system controller 40 of a primary camera checks if the shutter button 31 is pressed halfway, and repeats checking until the shutter button 31 is pressed halfway. When the shutter button 31 is pressed halfway, the system controller 40 executes the AF process and the AE process. Furthermore, the system controller 40 controls a decode/encode processor 62 to encode the condition dada, and superimpose the encoded data on a sound signal to produce a composite sound signal. The composite sound signal is output through a speaker 28. The sound signal may represent a peep, a beep or the like.

Thereafter the system controller 40 checks if the shutter button 31 is fully pressed, and repeats checking until the shutter button 31 is pressed to the full. When the shutter button 31 is pressed fully, the system controller 40 controls a sound controller 61 to drive the speaker 28 to output a specific sound notifying of the start of successive shots. Thereafter, the system controller 40 controls the respective parts of the primary camera on the basis of the condition data, to execute the successive shot process. When the successive shots are accomplished, the system controller 40 causes to output another specific sound for notifying of the end of the successive shot process, to terminate the synchronized successive shot process.

On the other hand, when a secondary camera is set to the synchronized successive shot mode, a system controller 40 of the secondary camera controls a decode/encode processor 62 to check if the condition data is detected, and repeat checking if the condition data is not detected. When the condition data is detected, the system controller 40 of the secondary camera sets up the conditions for successive shots according to the condition data. Thereafter the system controller 40 checks if the secondary camera receives the specific sound notifying of the start of successive shots, and repeats checking until the start of successive shots is notified.

When the sound notifying of the start of successive shots is received, the system controller 40 controls respective parts of the secondary camera to execute the successive shot process, while checking if the secondary camera receives the sound notifying of the end of the successive shot process. The secondary camera takes shots successively until it receives the sound notifying of the end of the successive shot process, and terminates the synchronized successive shot process upon receipt of this notifying sound.

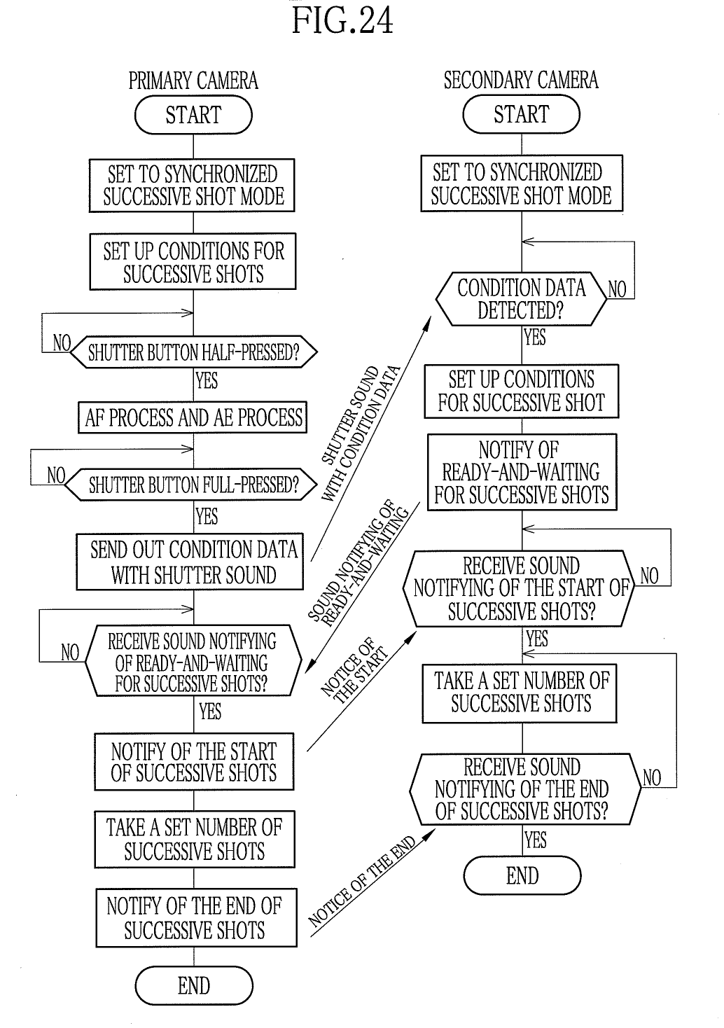

FIG. 24 illustrates still another embodiment wherein a primary camera starts the successive shot process after it receives a sound notifying of ready-and-waiting for the successive shots from a secondary camera. Procedures from the start to the AF and AE processes are the same as the embodiment of FIG. 23, so the description of these procedures will be skipped.

After accomplishing the AF and AE processes, a system controller 40 checks if a shutter button 31 is pressed fully. When the shutter button 31 is pressed to the full, the system controller 40 controls a decode/encode processor 62 to encode text data representative of conditions for successive shots, and superimpose the encoded data on a sound signal of a shutter sound to produce a composite sound signal, and outputs the shutter sound through a speaker 28.

Thereafter the system controller 40 checks if the primary camera receives the sound notifying of ready-and-waiting for the successive shots from the secondary camera, and repeats checking until receiving the sound notifying of ready-and-waiting. When the sound notifying of ready-and-waiting is received, the system controller 40 proceeds to a procedure for notifying the secondary camera of the start of successive shots. Thereafter, the same procedures as in the flowchart of FIG. 23 are executed, so the description of these procedures will be skipped.

On the other hand, when the secondary camera is set to the synchronized successive shot mode, a system controller 40 of the secondary camera controls a decode/encode processor 62 to check if the condition data is detected, and repeat checking until the condition data is detected. When the condition data is detected, the system controller 40 makes ready for successive shots by setting up the conditions designated by the condition data. After completing setting up the conditions, the system controller 40 notifies the primary camera that the secondary camera gets ready for the successive shot by controlling a sound controller 61 to output a specific sound through a speaker 28. Thereafter the system controller 40 proceeds to the process of checking if the secondary camera receives the sound notifying of the start of successive shots from the primary camera. Thereafter the secondary camera executes the same process as in the flowchart of FIG. 23, so the description is omitted.

Although the secondary camera notifies the primary camera that the secondary camera is ready and waiting for the successive shots by outputting a sound from the speaker in the embodiment of FIG. 24, it is possible to use wireless communication or light emission instead.

Although condition data representative of conditions for successive shots is encoded and superimposed on a sound signal representative of a shutter sound in the above embodiments, the encoded condition data may be superimposed on any other sound signal insofar as it represents an audible sound.

In the above embodiments, the sound controller and the decode/encode processor are provided as separate devices from the system controller, it is possible for the system controller to execute programs for the processes of the sound controller and the decode/encode processor.

Furthermore, the camera system of the present invention is not limited to one consisting of a single primary camera and a single secondary camera, but may consist of a primary camera and a plurality of secondary cameras.

Although the primary and secondary cameras have the same structure in the above embodiments, they may have different structures from each other. In that case, a primary camera is provided with a device for producing a composite sound signal, a speaker and a controller, whereas a secondary camera is provided with a microphone, a data detector and a second controller.

The present invention is not only applicable to a camera system consisting of digital cameras, but also to a camera system consisting of camera phones, a monitoring system consisting of monitoring cameras, or the like.

Thus the present invention is not to be limited to the above embodiments but, on the contrary, various modifications will be possible without departing from the scope of claims appended hereto.

What is claimed is:

1. An imaging system comprising a primary imaging apparatus and at least a secondary imaging apparatus, wherein said primary imaging apparatus comprises:
a first imaging device for converting an optical image of a subject into electronic image data;
a first controller for controlling said first imaging device to execute a successive shot process according to conditions set up for successive shots;
a device for producing a composite sound signal by encoding data of the conditions for successive shots and superimposing the encoded data on a predetermined sound signal; and
a speaker for outputting said composite sound signal as a sound, whereas said secondary imaging apparatus comprises:
a second imaging device for converting an optical image of a subject into an electric image signal;
a microphone for obtaining a sound signal from an external sound;
a data detector for decoding said composite sound signal as it is obtained through said microphone, to detect the data of the conditions for successive shots; and
a second controller for controlling said second imaging device to execute a successive shot process on the basis of the data of the conditions for successive shots.

2. An imaging system as recited in claim 1, wherein the conditions for successive shots include number of successive shots, speed of the successive shots, shutter speed and aperture value of each shot.

3. An imaging system as recited in claim 1, wherein said primary imaging apparatus outputs said composite sound signal when an input device for inputting a command for starting imaging is operated.

4. An imaging system as recited in claim 1, wherein said primary and secondary imaging apparatuses have a normal imaging mode for taking a single shot, and a successive shot mode for taking a plural number of shots successively, and wherein when said primary imaging apparatus is set to the successive shot mode, said speaker outputs a specific sound signal that is different from a sound signal in the normal imaging mode, so said second controller sets said secondary imaging apparatus to the successive shot mode when the specific sound signal is obtained through said microphone.

5. An imaging system as recited in claim 1, wherein said secondary imaging apparatus further comprises a storage device for storing the data of the conditions for successive shots temporarily.

6. An imaging system as recited in claim 5, wherein said speaker outputs said composite sound signal before each shot, so said second controller obtains the data of the conditions for successive shots before each shot.

7. An imaging system as recited in claim 6, wherein said second controller judges whether a previous one of the successive shots is correct or not on the basis of the data of the conditions used for the previous shot, and if the previous shot is incorrect, said second controller revises the data of the conditions for successive shots.

8. An imaging system as recited in claim 6, wherein said second controller judges whether a previous one of the successive shots is correct or not on the basis of the data of the conditions used for the previous shot, and if the previous shot is incorrect, said second controller corrects or deletes image data obtained through the previous shot.

9. An imaging system as recited in claim 1, wherein said primary imaging apparatus further comprises a first timer for outputting a timing signal and a light emitter, whereas said secondary imaging apparatus further comprises a second timer for outputting a timing signal, and wherein said first controller controls said light emitter to blink in accordance with the timing signal from said first timer, and said second controller detects the blinks of said light emitter through said second imaging device and adjusts the timing signal from said second timer to the timing signal from said first timer on the basis of the blinks of said light emitter.

10. An imaging system as recited in claim 1, wherein said primary and secondary imaging apparatuses further comprise a clock device for outputting exact time, and the data of the conditions for successive shots include information designating the time of starting successive shots and the timing of successive shots, so said first and second controller execute the successive shot process from the designated time at the designated timing.

11. An imaging system as recited in claim 1, wherein said primary and secondary imaging apparatuses further comprise first and second wireless communication devices respectively and have a wireless setup mode for setting up wireless communication between said primary and secondary imaging apparatuses, and when said primary and secondary imaging apparatuses are set to the wireless setup mode, said first controller controls said composite sound signal producing device to encode wireless communication setup information for said first wireless communication device and superimpose the encoded wireless communication setup information on a sound signal to produce a composite sound signal, whereas said second controller controls said data detector to detect the wireless communication setup information and sets up said second wireless communication device on the basis of the detected wireless communication setup information.

12. An imaging system as recited in claim 11, wherein said second controller releases the wireless setup mode after setting up said second wireless communication device, and controls said second wireless communication device to send a notice of completion of setting up wireless communication to said primary imaging apparatus.

13. An imaging system as recited in claim 12, wherein said first wireless communication device releases the wireless setup mode when said first wireless communication device receives the notice of completion of setting up wireless communication.

14. An imaging system as recited in claim 11, wherein user's voice is previously registered in said primary and secondary imaging apparatuses, and said composite sound signal producing device superimposes the wireless communication setup information on a sound signal of the registered user's voice, whereas said second controller accepts the wireless communication setup information only when the wireless communication setup information is superimposed on the sound signal of the registered user's voice.

15. An imaging system as recited in claim 1, wherein said first controller controls volume of said speaker or magnification of the encoded data appropriately while outputting the composite sound signal through said speaker.

16. An imaging system as recited in claim 1, wherein information for identifying said primary imaging apparatus is previously registered in said secondary imaging apparatus, and said first controller attaches the identifying information to the data of the conditions for successive shots as it is superimposed on the sound signal, whereas said second controller accepts the data of the conditions for successive shots only when the attached identifying information coincide with the registered identifying information.

17. An imaging system as recited in claim 16, wherein said primary imaging apparatus further comprises a light emitter, and drives said light emitter to blink according to a predetermined signal pattern for sending out the identifying information, whereas said secondary imaging apparatus receives the blink of said light emitter through said second imaging device to get the identifying information of said primary imaging apparatus and registers the identifying information.

18. An imaging system as recited in claim 16, wherein said primary and secondary imaging apparatuses further comprise wireless communication devices respectively, and the identifying information is sent from said primary imaging apparatus to said secondary imaging apparatus through said wireless communication devices.

19. An imaging system as recited in claim 16, wherein said primary and secondary imaging apparatuses can record and read data in and out of recording media, and the identifying information is recorded in a recording medium as it is loaded in said primary imaging apparatus, so the identifying information is registered in said secondary imaging apparatus through the recording medium.

20. An imaging system as recited in claim 16, wherein said primary imaging apparatus further comprises a display device, and drives said display device to display the identifying information, whereas said secondary imaging apparatus obtains the identifying information displayed on said display device through said second imaging device and register it.

21. An imaging system as recited in claim 3, wherein said input device comprises a two-step operating button, and said first controller controls said speaker to output the composite sound signal when said operating button is pressed halfway, and a sound notifying of the start of successive shots when said operating button is pressed fully to input the command for starting imaging, whereas said second control device controls said second imaging device to start the successive shot process upon receipt of said sound notifying of the start of successive shots.

22. An imaging system as recited in claim 1, wherein said secondary imaging apparatus further comprises a device for giving a notice to said primary imaging apparatus that said secondary imaging apparatus completes setting up the conditions for successive shots on the basis of the data of the conditions for successive shots, so said primary imaging device outputs a sound notifying of the start of successive shots upon receipt of said notice from said secondary imaging device, and said secondary imaging apparatus starts the successive shot process upon receipt of the sound notifying of the start of successive shots.

23. An imaging apparatus comprising:
an imaging device for converting an optical image of a subject into electronic image data;
a controller for controlling said imaging device to execute a successive shot process according to conditions set up for successive shots;
a device for producing a composite sound signal by encoding data of the conditions for successive shots and superimposing the encoded data on a predetermined sound signal; and
a speaker for outputting said composite sound signal as a sound.

24. An imaging apparatus comprising:
an imaging device for converting an optical image of a subject into an electric image signal;
a microphone for obtaining a sound signal from an external sound;
a data detector for decoding a composite sound signal as it is obtained through said microphone, to detect data of conditions for successive shots; and
a controller for controlling said imaging device to execute a successive shot process on the basis of the data of the conditions for successive shots.
